(19) United States
(12) Patent Application Publication
(10) Pub. No.: US 2005/0094626 A1
(43) Pub. Date: May 5, 2005

(54) Voice communication system, and communication apparatus, cable modem, and method for controlling communication apparatus used for the system

(76) Inventor: Katsunori Yoshihara, Koganei-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/948,146

(22) Filed: Sep. 24, 2004

(30) Foreign Application Priority Data
Sep. 29, 2003 (JP) 2003-337750

(51) Int. Cl. H04L 12/66

(52) U.S. Cl. 370/352

(57) ABSTRACT

A voice communication system includes a network which transmits a plurality of voice packets, a communication apparatus to communicate with an analog telephone terminal processing voice signal together with the network, and convert the voice signal into the voice packet, and convert the voice packet into the voice signal, a recorder which records a plurality of receiving voice packets received by the communication apparatus on a recording medium when an incoming call to the analog telephone terminal arises and it is impossible to control the incoming call to the analog telephone terminal, a managing circuit to manage the plurality of receiving voice packets on the recording medium by time.

### CROSS-REFERENCE TO RELATED APPLICATIONS

This application is based upon and claims the benefit of priority from prior Japanese Patent Application No. 2003-337750, filed Sep. 29, 2003, the entire contents of which are incorporated herein by reference.

### BACKGROUND OF THE INVENTION

1. Field of the Invention

The present invention relates to a system carrying out voice communication on a VOIP (Voice Internet Protocol) network carrying out packet transmission, and in particular, to a voice communication system in which an attempt is made to make a voice communication service function satisfactory, and a communication apparatus, a cable modem, and a method for controlling a communication apparatus which are used for the system.

2. Description of the Related Art

In recent years, a network telephone system (IP telephone system) sending and receiving image and audio in real-time as packet data in two-way via a packet network has been starting to be standardized.

In this IP telephone system, an IP telephone terminal is connected to a packet network, and the packet network is connected to a general telephone network such as a public switched telephone network or the like via a gateway, and due to protocol conversion and data format conversion being carried out in the IP telephone terminal and the gateway, voice communication can be carried out between IP telephone terminals each other, and between the IP telephone terminals and a general telephone network. Note that the IP telephone terminal may be constituted of a cable modem connected to the packet network and an analog telephone terminal connected to the cable modem.

Further, in the IP telephone system, a system in which the presence of a voice message is reported to a general telephone terminal via a gateway, and the voice message can be hear through the general telephone terminal is proposed (for example, in Jpn. Pat. Appln. KOKAI Publication No. 2001-309040.).

However, in the above-described system, because a called voice signal of a speaker and a received voice signal which has arrived from the general telephone network are made to be in packets and transmitted on a packet network, a delay of a packet incoming timing or a packet loss arises due to a traffic or the like on the packet network. In particular, when a delay of a voice packet is made to be over a threshold value, the voice packet is destroyed, and voice interruption or the like arises, and the sound quality deteriorates.

Accordingly, when an attempt is made to execute a recording service or a service of hearing recorded voice, a random gap in time arises between the receiving voice packets to be recorded each other, and as a result, it is difficult to carry out normal recording or hearing.

### BRIEF SUMMARY OF THE INVENTION

Then, an object of the present invention is to provide a voice communication system in which highly reproducible recording or hearing can be achieved even if a delay of a voice packet arises on a network for packet transmission, and to provide a communication apparatus, a cable mode, and a method for controlling a communication apparatus which are used for this system.

According to an aspect of the present invention, there is provided a voice communication system comprising: a network which transmits a plurality of voice packets; a communication apparatus to communicate with an analog telephone terminal processing voice signal together with the network, and convert the voice signal into the voice packet, and convert the voice packet into the voice signal; a recorder which records a plurality of receiving voice packets received by the communication apparatus on a recording medium when an incoming call to the analog telephone terminal arises and it is impossible to control the incoming call to the analog telephone terminal; and a managing circuit to manage the plurality of receiving voice packets on the recording medium by time.

According to another aspect of the present invention, there is provided a communication apparatus to communicate with an analog telephone terminal processing voice signal together with a network transmitting a plurality of voice packets, and convert the voice signal into the voice packet, and convert the voice packet into the voice signal, the communication apparatus comprising: a recorder which records a plurality of receiving voice packets which arrives from the network on a recording medium when an incoming call to the analog telephone terminal arises and it is impossible to control the incoming call to the analog telephone terminal; and a managing circuit which manages the plurality of receiving voice packets on the recording medium by time.

According to yet another aspect of the present invention, there is provided a cable modem to communicate with an analog telephone terminal processing voice signal together with a network transmitting voice packet, and convert the voice signal into the voice packet, and convert the voice packet into the voice signal, the cable modem comprising: a recorder which records receiving voice packets which arrives from the network when an incoming call to the analog telephone terminal arises and it is impossible to control the incoming call to the analog telephone terminal; and a managing circuit to manage the plurality of receiving voice packets on the recording medium by time.

According to yet another aspect of the present invention, there is provided a method for controlling a communication apparatus to communicate with an analog telephone terminal processing voice signal together with a network transmitting voice packet, and convert the voice signal into the voice packet, and convert the voice packet into the voice signal, the method for controlling a communication apparatus, comprising: recording a plurality of receiving voice packets received by the communication apparatus on a recording medium when an incoming call to the analog telephone terminal arises and it is impossible to control the incoming call to the analog telephone terminal; and managing the plurality of receiving voice packets on the recording medium by time.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram showing one embodiment of a voice communication system according to the present invention.

FIG. 2 is a block diagram showing a functional configuration of a cable modem shown in FIG. 1.

FIG. 3 is a diagram for explaining an operation at the time of conversation processing in a first embodiment of the present invention.

FIG. 4 is a diagram for explaining an operation at the time of conversation processing in the first embodiment.

FIG. 5 is a diagram for explaining an operation at the time of recording processing in the first embodiment.

FIG. 6 is a flowchart for explaining operations at the time of recording processing of the cable modem in the first embodiment.

FIG. 7 is a flowchart for explaining operations at the time of recording processing of the cable modem in the first embodiment.

FIG. 8 is a flowchart for explaining operations at the time of playback processing of the cable modem in a second embodiment of the present invention.

FIG. 9 is a flowchart for explaining operations at the time of playback processing of the cable modem in the second embodiment.

FIG. 10 is a flowchart for explaining operations at the time of playback processing of the cable modem in a third embodiment of the present invention.

FIG. 11 is a flowchart for explaining operations at the time of playback processing of the cable modem in the third embodiment.

### DETAILED DESCRIPTION OF THE INVENTION

Hereinafter, embodiments of the present invention will be described in detail with reference to the drawings.

### First Embodiment

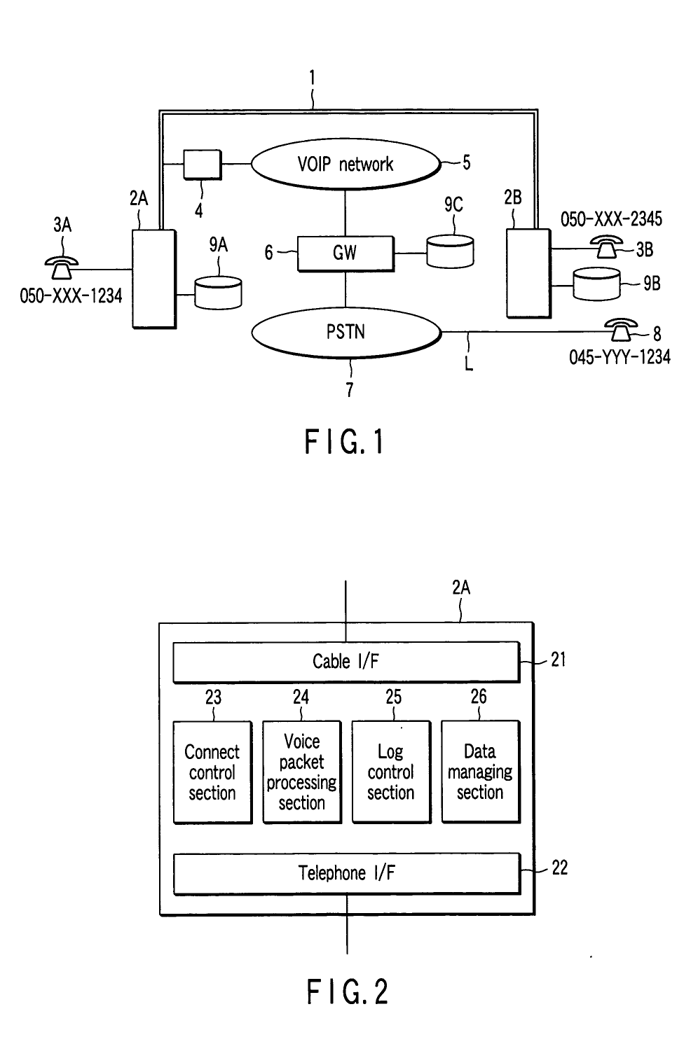

FIG. 1 is a schematic diagram showing one embodiment of a voice communication system according to the present invention.

This system has a coaxial cable 1. Cable modems 2A and 2B are connected to the coaxial cable 1. The cable modems 2A and 2B respectively connect between analog telephone sets 3A and 3B, and the coaxial cable 1, and have functions of converting communication protocols and signal formats between the telephone sets 3A and 3B, and the coaxial cable 1.

Moreover, a network-to-network connection device 4 (hereinafter the connection device 4) is connected to the coaxial cable 1. The connection device 4 connects between the coaxial cable 1 and a VOIP network 5, and has a function of converting communication protocols and signal formats between the coaxial cable 1 and the VOIP network 5.

A gateway (GW) 6 is connected to the VOIP network 5. The gateway 6 connects between the VOIP network 5 and a public switched telephone network 7 (hereinafter a PSTN 7), and has a function of converting a communication protocol and a signal format between the VOIP network 5 and the PSTN 7. A telephone set 8 is connected to the PSTN 7 via a telephone line L.

Incidentally, the cable modems 2A and 2B has a function as a function according to the present invention as follows. FIG. 2 is a block diagram showing the functional configuration thereof. Here, on behalf thereof, the cable modem 2A will be described.

That is, the cable modem 2A has a cable interface section 21 (hereinafter a cable I/F 21), a telephone set interface section 22 (hereinafter a telephone set I/F 22), a connect control section 23, a voice-packet processing section 24 (hereinafter a packet processing section 24), a log control section 25, and a data managing section 26.

The connect control section 23 carries out a connection control between the coaxial cable 1 and the telephone set 3A. The packet processing section 24 has a function of converting a sound signal received from the telephone set 3A into a voice packet which can be handled through the coaxial cable 1 and transmitting it to the coaxial cable 1, and of converting the voice packet received from the coaxial cable 1 into a sound signal which can be handled by the telephone set 3A and transmitting it to the telephone set 3A.

The log control section 25 records the receiving voice packet arriving from a caller in a storage device 9A when there is no answering within a given time when an incoming call to the telephone set 3A arises.

The data managing section 26 manages the receiving voice packets in the storage device 9A based on sequence numbers which have been inserted into the headers of the receiving voice packets, and which denote the orders of transmitting the packets after starting of the communication.

Next, voice communication operations by the system configured as described above will be described.

First, basic communication connecting processing will be described.

For example, telephone numbers will be provided as terminal identification information to the telephone sets 3A and 3B, and these telephone numbers are stored in the connection device 4 and a storage device 9C of the gateway 6. Further, routing information for determining an incoming call destination at the time of incoming call from the PSTN 7 is stored in the gateway 6.

For example, suppose that a speaker of a telephone set 8 connected to the PSTN 7 dials “050-XXX-1234” on the telephone set 8 in order to carry out voice communication with the telephone set 3A connected to the cable modem 2A. Then, an incoming call signal is transmitted from the PSTN 7 to the gateway 6. The gateway 6 which received this incoming call signal transmits a connection request signal to the telephone set 3A corresponding to “050-XXX-1234” via the VOIP network 5, the connection device 4, and the coaxial cable 1, by referring to the routing information.

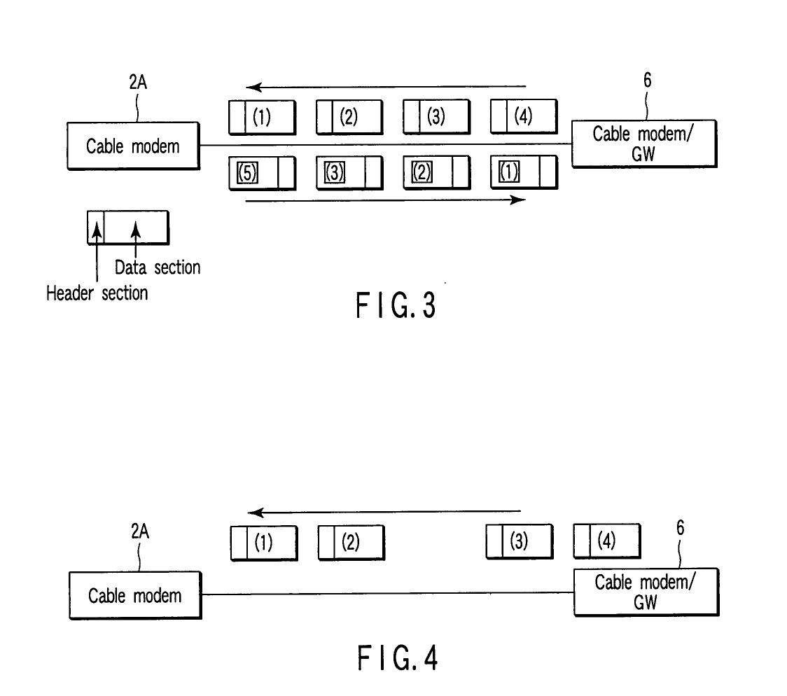

A ringing tone is generated at the telephone set 3A which received the connection request signal, and thereby it is reported to the user that an incoming call arose. Then, when the user carries out answering operation with respect to the incoming call report, the telephone set 3A transmits a connection answer signal to the gateway 6 which is the requesting origin. The gateway 6 which received the connection answer signal transmits an answer signal to the PSTN 7. In this way, a communication path is formed between the telephone set 8 which is the calling origin and the telephone set 3A which is the incoming call destination, and hereinafter, as shown in FIG. 3, voice communication is possible between the both telephone sets 3A and 8.

Here, the voice packet which is transmitted and received is formed from a header section and a data section. At the header section, information corresponding to a sequence number and an elapsed time from the time of starting conversation is set.

When the traffic of the VOIP network 5 is low, a delay of the voice packet is little, and the voice packet arrives the called party at substantially given intervals. On the other hand, when the traffic of the VOIP network 5 is high, as shown in FIG. 4, a delay of or a jitter in the voice packet is made large.

In the cable modem 2A, a threshold value relating to a delay of or a jitter in a voice packet is set, and because a voice packet which is over the threshold value is destroyed, voice interruption arises, and the sound quality deteriorates.

In real-time communication, even when the destruction of the voice packet which is over the threshold value arises, it is possible to avoid the problem by making the called party speak the same contents again. However, when a voice message is recorded in an automatic answering telephone set or a facsimile machine because of the absence of the user, it will be a fatal problem.

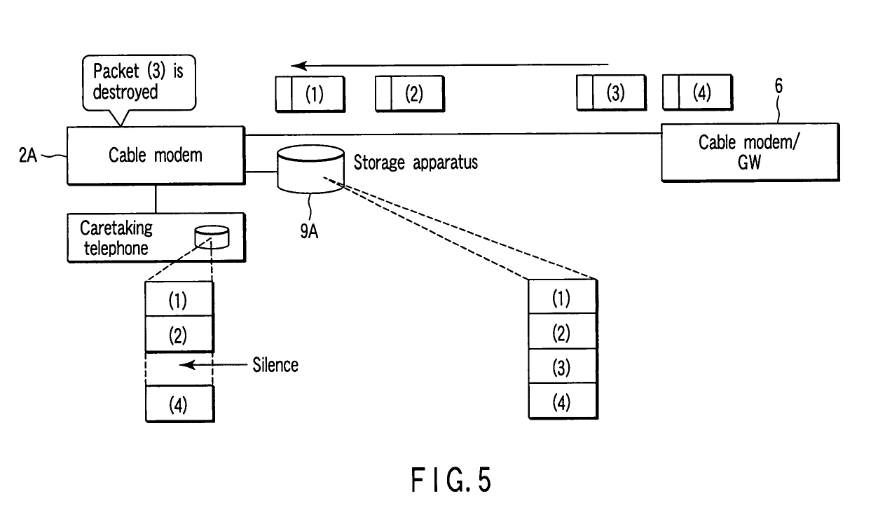

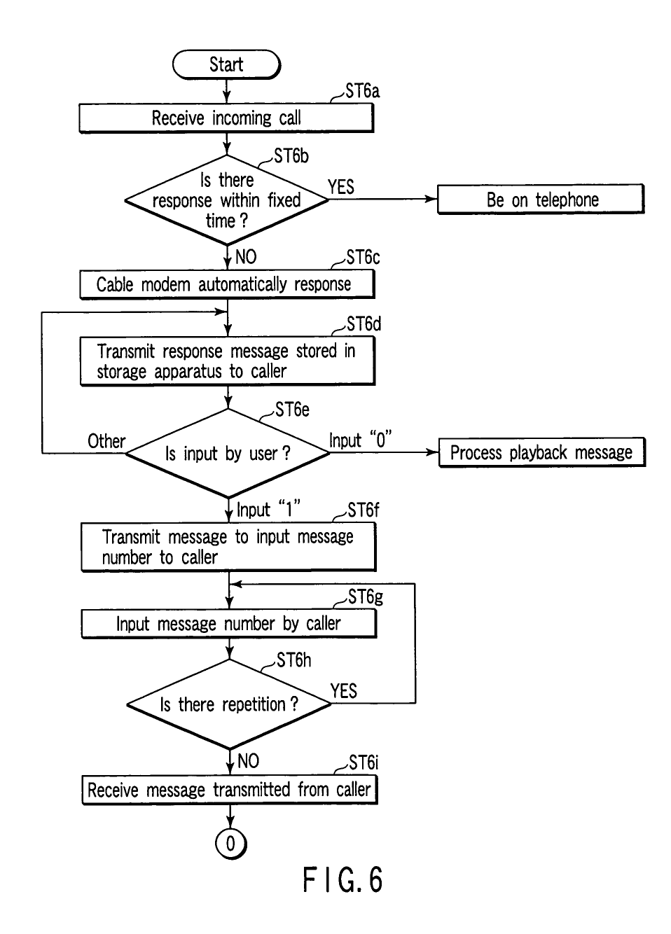

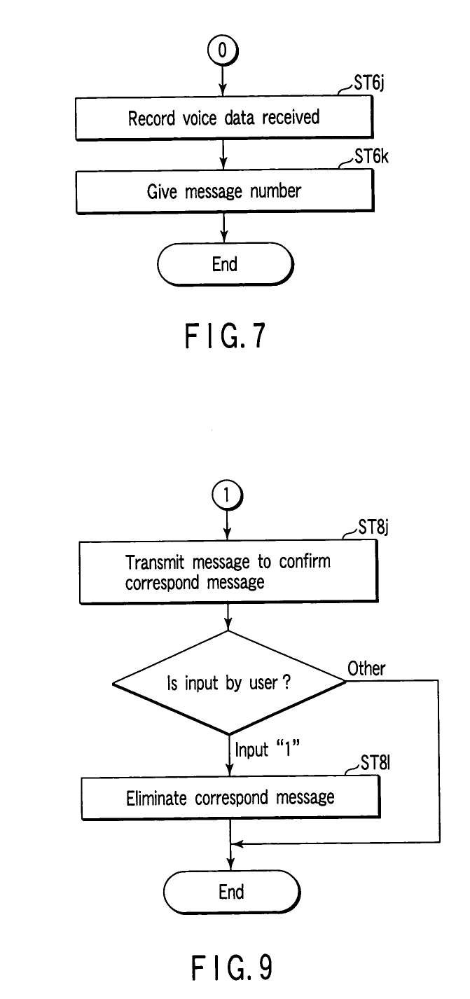

Next, operations of recording processing will be described with reference to FIG. 5 to FIG. 7.

Here, suppose that an answer monitoring time at the time of incoming call with respect to the telephone set 3A is set to, for example, 9 seconds.

For example, suppose that the speaker of the telephone set 8 connected to the PSTN 7 dials “050-XXX-1234” on the telephone set 8 in order to carry out voice communication with the telephone set 3A connected to the cable modem 2A, and a connection request signal is reported to the telephone set 3A (step ST6a). Then, the cable modem 2A monitors whether the user of the telephone set 3A answers or not within an answer monitoring time (step ST6b), and when the user does not answer within 9 seconds, automatic answering is carried out with respect to the incoming call report, and a communication path is formed between the cable modem 2A and the telephone set 8 which is the calling origin (step ST6c).

Then, the cable modem 2A transmits a message “I am away at the moment. If you have a message . . . ” which the user has registered in advance, to the gateway 6, and the message is reported to the speaker of the telephone set 8 which is the calling origin (step ST6d). Suppose that the speaker of the telephone set 8 presses the key “1” in order to leave a message with respect to this report (step ST6e). Then, the cable modem 2A transmits a message to urge the speaker of the telephone set 8 to input a four-digit message number (step ST6f). When the speaker of the telephone set 8 inputs the four-digit message number with respect to the message (step ST6g), the cable modem 2A determines whether or not the input message number is overlapped with a message number registered in the storage device 9A (step ST6h). Then, when those are overlapped with one another, the routine proceeds to step ST6g, and the speaker of the telephone set 8 is made to do inputting over again, and when those are not overlapped with one another, the voice packet transmitted from the telephone set 8 is received (step ST6i).

The cable modem 2A extracts sequence numbers denoting the orders of transmitting the packets from the respective header sections of the receiving voice packets received from the telephone set 8. Further, the cable modem 2A calculates an address of a voice message storage area in the storage device 9A, and records data in the received receiving voice packet in the address (step ST6j).

Then, by a report of disconnection of the telephone set 8, the cable modem 2A completes recording to the voice message storage area in the storage device 9A, and provides a message number thereto (step ST6k).

As described above, in the first embodiment, when an incoming call arises on the telephone set 3A, and it is impossible to control the incoming call, all of the receiving voice packets to be left as messages are recorded in the storage device 9A by the cable modem 2A, and the receiving voice packets in the storage device 9A are managed by time by utilizing sequence numbers inserted in the header sections of the respective receiving voice packets.

Accordingly, there is no case in which the receiving voice packets are destroyed even when a delay greater than or equal to the threshold value arises between the receiving voice packets arriving from the VOIP network 5 and the coaxial cable 1, and all of the receiving voice packets are recorded in the storage device 9A in a state in which the delays are absorbed, and are managed by time, and thereby those can be always recorded in a good sound quality.

### Second Embodiment

A second embodiment of the present invention relates to the above-described cable modems 2A and 2B. Here, the data managing sections 26 of the cable modems 2A and 2B have functions of playing-back or erasing corresponding messages in the storage devices 9A and 9B according to a playback request or an erasing request.

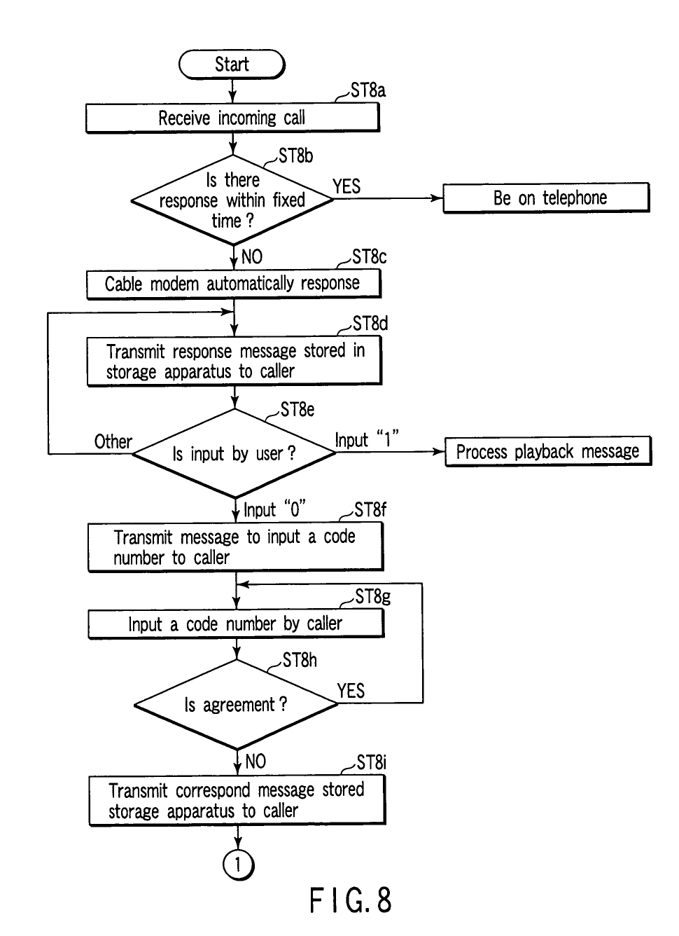

FIG. 8 and FIG. 9 are flowcharts showing processing operations of the cable modem 2A in the second embodiment.

Here, a method in which the user of the cable modem 2A identifies or erases a voice message will be described. In advance, the user of the cable modem 2A registers a personal identification number or a command code for confirming (hearing) or erasing a voice message recorded in the storage device 9A. The means for registering will be not described here. However, a method of registering from the telephone set 3A connected to the cable modem 2A, and a method of registering from a personal computer (not shown) connected to the cable modem 2A can be considered. Here, suppose that “1234” serving as a personal identification number, “#1” serving as a command code for hearing a message, and “#2” serving as a command code for erasing a message are registered in the cable modem 2A.

The user inputs “050-XXX-1234” which is the telephone number of the telephone set 3A connected to the cable modem 2A from a portable telephone, a public telephone, or the like. Then, a connection request signal is reported to the telephone set 3A (step ST8a).

Then, the cable modem 2A monitors whether the user of the telephone set 3A answers or not within an answer monitoring time (step ST8b), and when the user does not answer within 9 seconds, automatic answering is carried out with respect to the incoming call report, and a communication path is formed between the cable modem 2A and the calling origin (step ST8c).

Then, the cable modem 2A transmits a message “I am away at the moment. If you have a message . . . ” which the user has registered in advance, to the gateway 6, and the message is reported to the calling origin (step ST8d). Suppose that the user presses the key “0” in order to confirm a message with respect to this report (step ST8e). Then, the cable modem 2A transmits a message to urge the user to input a personal identification number (step ST8f). When the user inputs the personal identification number with respect to this message (step ST8g), the cable modem 2A determines whether or not the input personal identification number is coincident with a personal identification number registered in the storage device 9A (step ST8h). Then, when those are not coincident with one another, the routine proceeds to step ST8g, and the user is made to do inputting over again, and when those are coincident with one another, the corresponding message recorded in the storage device 9A is transmitted to the calling origin. (step ST8i).

After the transmission of the message is completed, the cable modem 2A transmits a message for confirming the presence of erasing of the corresponding message to the calling origin (step ST8j). Here, when the user presses the key “1” in order to erase the message (step ST8k), the cable modem 2A erases the corresponding message from the storage device 9A (step ST8l).

As described above, in the second embodiment, the personal identification number has been registered in the cable modem 2A or the storage device 9A in advance to authenticate the user, and when a playback request arrives, the requesting origin is urged to input a personal identification number, and it is determined whether those are coincident with one another or not by comparing the input personal identification number with the registered personal identification number, and when those are coincident with one another, the corresponding message recorded in the storage device 9A is transmitted to the requesting origin.

Accordingly, hearing of the receiving voice packet recorded in the storage device 9A can be carried out by inputting a personal identification number from a portable telephone or the like while the user of the telephone set 3A is away. Further, the receiving voice packet in the storage device 9A can be prevented from being purposely heard by a third party.

Note that, in the second embodiment, the personal identification number is registered as the authentication of the user in the cable modem 2A. However, for example, by utilizing a caller ID display service or the like, a telephone number of a portable telephone set which the user has used is registered in advance in the cable modem 2A, and the authentication of the user may be carried out according to whether an incoming call is an incoming call from the portable telephone or not. In this way, because there is no need to memory the personal identification number and to input the personal identification number, the convenience of the user is improved.

### Third Embodiment

A third embodiment of the present invention relates to the above-described cable modems 2A and 2B.

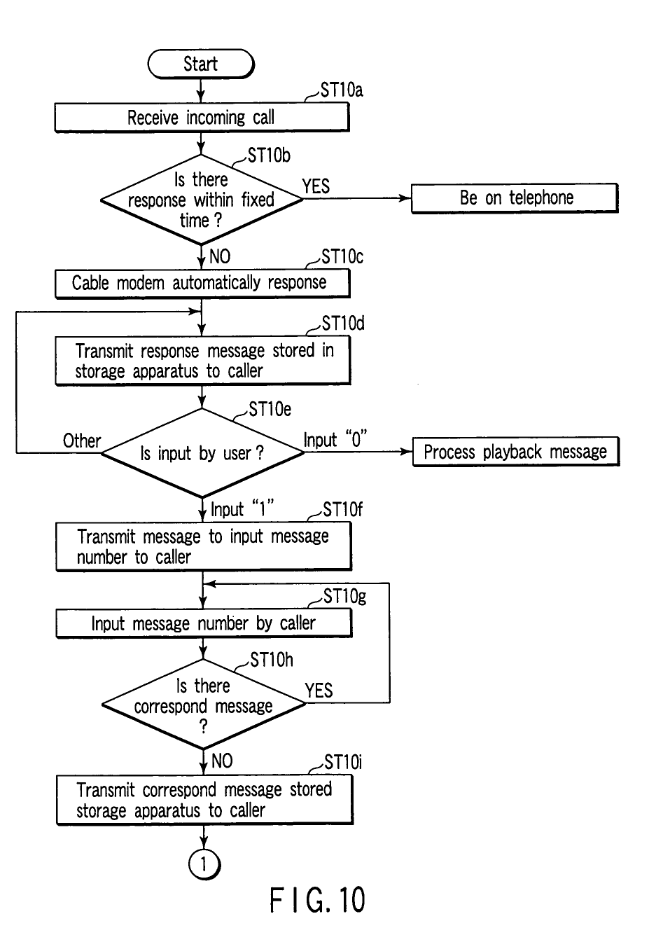

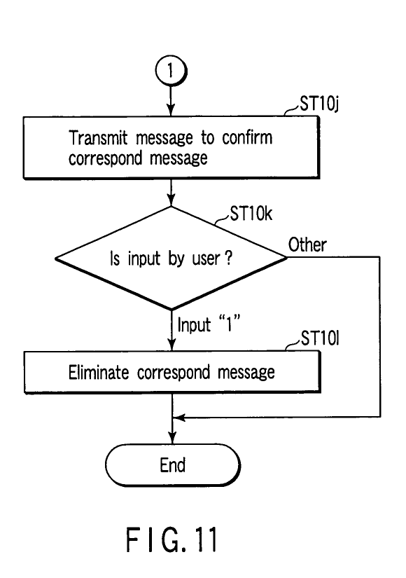

FIG. 10 and FIG. 11 are flowcharts showing processing operations of the cable modem 2A in the third embodiment.

Here, processing when the person who left a voice message carries out hearing or erasing of the message will be described.

For example, suppose that the speaker of the telephone set 8 connected to the PSTN 7 dials “050-XXX1234” on the telephone set 8 in order to carry out voice communication with the telephone set 3A connected to the cable modem 2A, and a connection request signal is reported to the telephone set 3A (step ST10a). Then, the cable modem 2A monitors whether the user of the telephone set 3A answers or not within an answer monitoring time (step ST10b), and when the user does not answer within 9 seconds, automatic answering is carried out with respect to the incoming call report, and a communication path is formed between the cable modem 2A and the telephone set 8 which is the calling origin (step ST10c).

Then, the cable modem 2A transmits a message “I am away at the moment. If you have a message . . . ” which the user has registered in advance, to the gateway 6, and the message is reported to the speaker of the telephone set 8 which is the calling origin (step ST10d). Suppose that the speaker of the telephone set 8 presses the key “0” in order to confirm or erase the message left in the storage device 9A by the speaker himself/herself with respect to this report (step ST10e). Then, the cable modem 2A transmits a message to urge the speaker of the telephone set 8 to input a four-digit message number (step ST10f). When the speaker of the telephone set 8 inputs the four-digit message number with respect to this message (step ST10g), the cable modem 2A determines whether or not there is a corresponding message in the storage device 9A (step ST10h).

Then, when there is a corresponding message, the cable modem 2A transmits the corresponding message recorded in the storage device 9A to the calling origin (step ST10i).

After the transmission of the message is completed, the cable modem 2A transmits a message for confirming the presence of erasing of the corresponding message to the calling origin (step ST10j). Here, when the speaker of the telephone set 8 presses the key “1” in order to erase the message (step ST10k), the cable modem 2A erases the corresponding message from the storage device 9A (step ST10l).

As described above, according to the third embodiment, when the speaker of the telephone set 8 which is the calling origin records a message of the speaker himself/herself in the storage device 9A so as to correspond to a message number, the speaker of the telephone set 8 can carry out hearing or erasing of the message by the speaker himself/herself which has been recorded in the storage device 9A by inputting a message number at the time of a playback request or the time of an erasing request in order to confirm or erase the message recorded in the storage device 9A. Therefore, the speaker of the telephone set 8 can confirm again the message left by the speaker himself/herself in the storage device 9A, and can erase the message left in error.

### Other Embodiments

The present invention is not limited to the respective embodiments. For example, in the first embodiment, the management of the receiving voice packets by time is carried out based on the sequence numbers inserted in the header sections of the receiving voice packets. However, the present invention is not limited thereto, the management of the receiving voice packets by time may be carried out based on stamp information denoting transmitting time inserted in the header sections of the receiving voice packets. As a result, the management of the receiving voice packets by time can be even precisely carried out.

Further, in the respective embodiments, the example in which the data managing section is provided in the cable modem has been described. However, the data managing section may be provided at the exterior of the cable modem.

Moreover, in the respective embodiments, the example in which the cable modem is used has been described. However, in addition to the cable modem, for example, a communication device such as a gateway or the like may be used.

Additionally, a type and a configuration of a system, a configuration of a cable modem, a type of a telephone set, means for managing recorded voice packets by time, or the like can be variously modified and implemented within a range which does not deviate from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A voice communication system comprising:
a network which transmits a plurality of voice packets;
a communication apparatus to communicate with an analog telephone terminal processing voice signal together with the network, and convert the voice signal into the voice packet, and convert the voice packet into the voice signal;
a recorder which records a plurality of receiving voice packets received by the communication apparatus on a recording medium when an incoming call to the analog telephone terminal arises and it is impossible to control the incoming call to the analog telephone terminal; and
a managing circuit to manage the plurality of receiving voice packets on the recording medium by time.

2. A voice communication system according to claim 1, wherein the communication apparatus is a cable modem.

3. A communication apparatus to communicate with an analog telephone terminal processing voice signal together with a network transmitting a plurality of voice packets, and convert the voice signal into the voice packet, and convert the voice packet into the voice signal,
the communication apparatus comprising:
a recorder which records a plurality of receiving voice packets which arrives from the network on a recording medium when an incoming call to the analog telephone terminal arises and it is impossible to control the incoming call to the analog telephone terminal; and
a managing circuit which manages the plurality of receiving voice packets on the recording medium by time.

4. A communication apparatus according to claim 3, wherein the managing circuit manages a plurality of receiving voice packets on the recording medium based on time stamp information, when the time stamp information is added to each of the receiving voice packets.

5. A communication apparatus according to claim 3, wherein the managing circuit manages a plurality of receiving voice packets on the recording medium based on index information denoting an order of transmitting the packet, when the index information is added to each of the receiving voice packets.

6. A communication apparatus according to claim 3, wherein the managing circuit reads at least one of the plurality of receiving voice packets on the recording medium and transmits it to a requesting destination in response to a playback request.

7. A communication apparatus according to claim 6, when authentication information has been registered on the recording medium in order to authenticate a user,
wherein the managing circuit includes:
a requesting circuit to request transmission of the authentication information with respect to a requesting origin when a playback request arises; and
a controller which reads at least one of the plurality of receiving voice packets on the recording medium and transmits it to the requesting destination, when the authentication information arrives in response to the request and the arriving authentication information is coincident with the authentication information on the recording medium.

8. A communication apparatus according to claim 7, wherein the managing circuit uses a caller number as the authentication information.

9. A communication apparatus according to claim 3, wherein the managing circuit erases at least one of the plurality of receiving voice packets on the recording medium in response to an erasing request.

10. A communication apparatus according to claim 9, when authentication information has been registered on the recording medium in order to authenticate a user,
wherein the managing circuit includes:
a requesting circuit to request transmission of the authentication information with respect to a requesting origin when an erasing request arises; and
a controller which erases at least one of the plurality of receiving voice packets on the recording medium, when the authentication information arrives in response to the request, the arriving authentication information is coincident with the authentication information on the recording medium.

11. A communication apparatus according to claim 10, wherein the managing circuit uses a caller number as the authentication information.

12. A communication apparatus according to claim 3, when packet identification information for identifying the receiving voice packet is added to each of the receiving voice packets,
wherein the managing circuit manages the plurality of receiving voice packets on the recording medium so as to correspond to the packet identification information.

13. A communication apparatus according to claim 12, wherein the managing circuit carries out at least one of transmitting and erasing of a corresponding receiving voice packet on the recording medium based on the packet identification information, when the packet identification information is added to at least one of the playback request and the erasing request.

14. A cable modem to communicate with an analog telephone terminal processing voice signal together with a network transmitting a plurality of voice packets, and convert the voice signal into the voice packet, and convert the voice packet into the voice signal,
the cable modem comprising:
a recorder which records receiving voice packets which arrives from the network when an incoming call to the analog telephone terminal arises and it is impossible to control the incoming call to the analog telephone terminal; and
a managing circuit to manage the plurality of receiving voice packets on the recording medium by time.

15. A method for controlling a communication apparatus to communicate with an analog telephone terminal processing voice signal together with a network transmitting a plurality of voice packets, and convert the voice signal into the voice packet, and convert the voice packet into the voice signal,
the method for controlling a communication apparatus, comprising:
recording a plurality of receiving voice packets received by the communication apparatus on a recording medium when an incoming call to the analog telephone terminal arises and it is impossible to control the incoming call to the analog telephone terminal; and
managing the plurality of receiving voice packets on the recording medium by time.
